(19) United States
(12) Patent Application Publication
(10) Pub. No.: US 2007/0180499 A1
(43) Pub. Date: Aug. 2, 2007

(54) Authenticating clients to wireless access networks

(76) Inventor: Jeroen Van Bemmel, Leiden (NL)

Correspondence Address: WILLIAMS, MORGAN & AMERSON, 10333 RICHMOND, SUITE 1100, HOUSTON, TX, 77042, US

(21) Appl. No.: 11/344,522

(22) Filed: Jan. 31, 2006

(51) Int. Cl. H04L 9/32

(52) U.S. Cl. 726/4

(57) ABSTRACT

The present invention provides a method and an apparatus for authenticating a client on a wireless network having an address that enables access to a server associated with the wireless network. In one embodiment, a method calls for assigning the address to the client for providing access to the wireless network before finishing authenticating the client based on a first response from the client to a first challenge from the server and a second response from the server to a second challenge from the client in response to a communication between the client and the server over the wireless network. A wireless communication system includes a client module for authenticating a mobile device to a Wi-Fi network through an access point associated therewith. For the purposes of authentication, an intermediate server may enable a server module to mutually authenticate the mobile device and the Wi-Fi network based on exchange of signaling messages between the client module and a server module associated with the Wi-Fi network via the intermediate server.

### 1. FIELD OF THE INVENTION

This invention relates generally to telecommunications, and more particularly, to wireless communications.

### 2. DESCRIPTION OF THE RELATED ART

Many communication systems provide different types of services to users of wireless devices. In a particular wireless service, wireless communication networks may enable wireless device users to exchange peer-to-peer and/or client-to-server messages, which may be simply text messages or include multi-media content, such as data and/or video. This exchange of messages involves establishment of a connection between a source device through a number of network routers that incrementally advance a message towards its destination to a target device.

Among other things, authentication of users is desired for access control to data or communication access networks. Wireless users may also require authentication of the network, especially since the technology required to impersonate a valid network has become cheap and widely available, in particular in case of Institute of Electrical and Electronics Engineers (IEEE) 802.11 based networks. The authentication process must be secure, but—especially during a handover while the user has ongoing sessions—it must also be fast. This invention provides a solution which represents a good trade-off between these two requirements, i.e. both fast and sufficiently secure. For example, in relatively large multi-domain networks, in which Dynamic Host Configuration Protocol (DHCP) servers (typically located on gateways, the first router and/or switch that packets from clients pass) have no a priori knowledge of clients that may attempt to connect (as may be the case in enterprise networks). Dynamic Host Configuration Protocol (DHCP) is a communications protocol for managing and automating the assignment of Internet Protocol (IP) addresses to devices to connect to a network.

Generally, a wireless LAN includes a wireless access point (AP) that communicates with a network adapter to extend a wired LAN. A user with a Wi-Fi compliant wireless communication device may use any type of access point with any other brand of client hardware that also is based on the IEEE 802.11 standard. The term Wi-Fi, short for wireless fidelity is promulgated by the Wi-Fi Alliance to refer any type of the IEEE 802.11 standard based device or network, whether 802.11a, 802.11b, 802.11g, dual-band, and the like. The Wi-Fi Alliance is an industry alliance to promote wireless networking arrangements according to the IEEE 802.11 specification. Typically, however, any Wi-Fi compliant wireless communication device using the same radio frequency (RF) signal, for example, 2.4 GHz for 802.11b or 11g, 5 GHz for 802.11a may work with any other wireless communication device.

However, regardless of the frequency range usage or type of a network employed, before granting an access to a user of a wireless communication device to a WAN, the user is typically authenticated. Therefore, most deployed Wi-Fi hotspots require a user to authenticate based on a user name and a password. Besides such authentication, other solutions for authentication may be deployed, e.g., among others, an authentication process based on the IEEE 802.1x standard is also available.

Network authentication in wireless networks which cannot rely on the security provided by physical connections is much more challenging than wired environment. For example, hotspots typically use web-based authentication of users, i.e. a user has to enter a username and password on a web page that pops up the first time the user enters the hotspot. Another technology that is becoming more popular is IEEE 802.1x, which uses the EAPOL (Extensible Authentication Protocol (EAP) over LAN) protocol to establish a secure, authenticated association with a given access point. EAP was originally used for dial-in connections typically use in PPP-based authentication.

After authentication, all of the above methods have in common that address acquisition must also be done before communication is possible. This typically uses DHCP which adds another delay. Request For Comments (RFC) documents published and coordinated by the Internet Engineering Task Force (IETF) describe an informal Internet standard, such as RFC2131 describes the DHCP protocol, which is used illustratively in the description of this invention. Although nothing in the DHCP specification prevents the client from using the IP address found in a DHCP OFFER as soon as it is received, typical current implementations wait until the final DHCP response has been received. This approach is unnecessarily limiting. RFC3118 describes Authentication for DHCP Messages. This defines one possible way to encode the messages and data exchanges required for implementing the current invention, and enables integrity protection of messages and mutual authentication.

One drawback of web-based authentication is that it requires user interaction, which prohibits fast authentication (users take seconds to enter their credentials). Even when this process is automated (which compromises security since the credentials must then be stored on the user's device) this option will not be able to achieve 100 ms handover times required to maintain a Voice over Internet Protocol (VoIP) session without audible effects.

EAP-based methods require one or more round trips to a backend AAA server, which easily takes several seconds in today's networks. Some of the more secure methods such as EAP-SIM also use interaction with a SIM card at the user's device, which adds additional delay. Overall EAP-based solutions typically achieve 2 second authentication at their best (in realistic settings).

RFC3118 prescribes that the DHCP server must have or be able to retrieve keys for all clients. Storing keys for all clients on each DHCP server in the network does not scale well (is unmanageable), and retrieving client keys across some backend network as needed is not secure. The technique described in Appendix A to generate a secret master key and issue a key K=MAC (MK, unique-id) for each client only applies to small scale networks in which the DHCP server knows all clients in advance. In section 9.2, the RFC3118 specification indicates that “Delayed authentication does not support inter-domain authentication” (since it does not scale well).

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of, one or more of the problems set forth above.

In one embodiment of the present invention, a method is provided for authenticating a client on a wireless network having an address that enables access to a server associated with the wireless network. In one embodiment, a method calls for assigning the address to the client for providing access to the wireless network before finishing authenticating the client based on a first response from the client to a first challenge from the server and a second response from the server to a second challenge from the client in response to a communication between the client and the server over the wireless network.

In another embodiment, a wireless client-server communication system to authenticate a client to a Wi-Fi network having an address that enables access to a server associated with the Wi-Fi network. The wireless client-server communication system may comprise a client and a server. The client includes a client module storing instructions for mutually authenticating to the wireless network through an access point associated with the wireless network. The server may be adapted to communicate with the client using an authenticator, the server including a server module storing instructions to mutually authenticate the client to the wireless network in response to a communication between the client and the server over the wireless network, the authenticator to assign the address to the client for providing access to the Wi-Fi network before finishing authenticating the client based on a first response from the client to a first challenge from the server and a second response from the server to a second challenge from the client.

In yet another embodiment, a client in a wireless client-server communication system to authenticate a client to an access network having an address that enables access to a server associated with the access network. The client comprises a client module storing instructions for mutually authenticating to a server module through an intermediate server that in response to a communication between the client module and the server module over the access network to assign the address to the client for providing access to the access network before finishing authenticating the client based on a first response from the client to a first challenge from the server and a second response from the server to a second challenge from the client.

In still another embodiment, a server in a wireless client-server communication system to authenticate a client to an access network having an address that enables access to the server associated with the access network. The server comprises a server module storing instructions for mutually authenticating to a client module through an intermediate server that in response to a communication between the client module and the server module over the access network to assign the address to the client for providing access to the access network before finishing authenticating the client based on a first response from the client to a first challenge from the server and a second response from the server to a second challenge from the client.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts one embodiment of an access network in which a client and the access network may mutually authenticate one another, in accordance with one embodiment of the present invention;

FIG. 2 depicts interaction between the client and the server between the client and the gateway having the intermediate server as the DHCP server and an AAA server are illustrated in accordance with one embodiment of the present invention;

FIG. 3 schematically illustrates a wireless client-server communication system to include a mobile device coupled to the AAA server to mutually authenticate with a Wi-Fi network, in accordance with one embodiment if the present invention; and

FIG. 4 shows a stylized representation for implementing a method of for authenticating the client on the access network as shown in FIG. 1 is illustrated in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for authenticating a client on a wireless network having an address that enables access to a server associated with the wireless network. In one embodiment, a method calls for assigning the address to the client for providing access to the wireless network before finishing authenticating the client based on a first response from the client to a first challenge from the server and a second response from the server to a second challenge from the client in response to a communication between the client and the server over the wireless network. A wireless communication system includes a client module at a mobile device for authenticating to a Wi-Fi network through an access point associated therewith. For the purposes of authentication, an intermediate server may enable a server module to mutually authenticate with the client module based on exchange of signaling messages with the client module via the intermediate server. By early acceptance or usage of an IP address from an offer as soon as it is received, a wireless communication system may reduce authentication time.

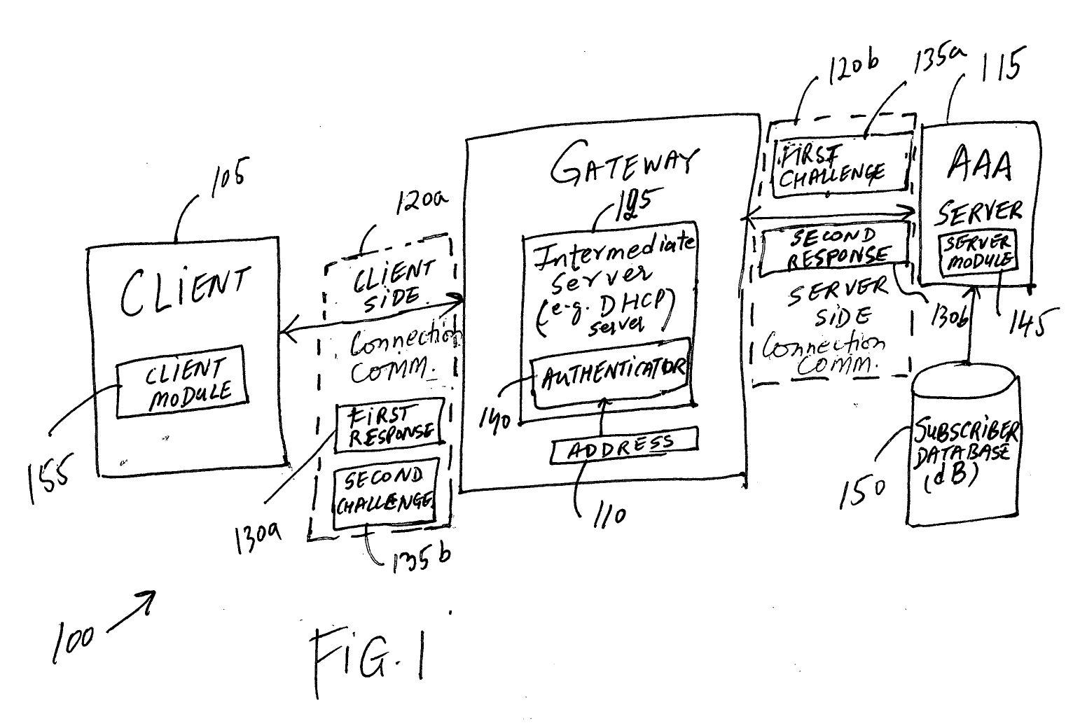

Referring to FIG. 1, an access network 100 is schematically depicted in which a client 105 and the access network 100 may mutually authenticate, in accordance with one embodiment of the present invention. For the purposes of mutually authenticating of the client 105 on a wireless network, such as a Wi-Fi network, the access network 100 having an address 110 may enable access to a server 115, such as an Authentication, Authorization, and Accounting (AAA) server. However, the three services desired by a network access server (NAS) server or protocol may be logically independent and may be separately implemented. Moreover, such a network access server may comprise one or more modems that provide access to the access network 100, allowing a user connecting to one of the modems to access the access network 100 the access network 100.

The access network 100 may further comprise a gateway 122 that determines which AAA server belongs to a given domain and (if known) generates a (random) client_challenge. The gateway 122 may select the address 110, for example, an IP address for the client 105 and sends that back. The gateway 122 may enable communication from and to the IP address (for a time-limited period larger than a typical response time for the server 115, i.e., the AAA server). The gateway 122 may also formulate a request for authentication comprising a server_challenge and the client_challenge, and sends that to a suitable AAA server.

To authenticate the client 105, the access network 100 may exchange a client side communication 120a and a server side communication 120b through an intermediate server 125. Examples of the intermediate server 125 may use a communications protocol, such as a Dynamic Host Configuration Protocol (DHCP). By using the DHCP protocol, the intermediate server 125 may automate assignment of the address 110, such as Internet Protocol (IP) addresses in the access network 100. In this way, the DHCP protocol based intermediate server 125 may enable the client 105 to connect to the access network 100 and automatically assigned an IP address.

For providing access to the access network 100 before authenticating the client 105, at least one of the client side communication 120a and server side communication 120b may initiate communication, such as the intermediate server 125 or vice versa, the DHCP server may assign the address 110 to the client 105.

In response to a communication between the client 105 and the server 115 over the access network 100, the intermediate server 125 may assign the address 110 to the client 105 for providing access to the access network 100 before finishing authenticating the client 105. The intermediate server 125 may authenticate the client 105 based on a first response 130a from the client 105 to a first challenge 135a from the server 115 and a second response 130b from the server 115 to a second challenge 135b from the client 105.

The gateway 122 may compare the first response 130a from the client 105 with the second response 130b from the server 115. If the two responses match, then it means that the client 105 knew the password and it's authenticated. The gateway 122 does not know the password of the client 105 but only knows the response. The gateway 122 learns from the server 115 what the response should be and if the client 105 actually provides the response it means that the client 105 is valid.

The server 115, such as the AAA server may calculate or digest the client's 105, the first challenge 135a and the password and other bits of information. The client 105 may wait until after predetermined number of time periods before starting to use the address 110 and the client 105 would not expect a challenge for authentication, such as embedded into one or more DHCP messages.

To this end, the gateway 122 may include the server 115, which comprises an authenticator 140 having the responsibility to provide early access to the client 105 before even finishing the authentication by the authentication server 115. The authenticator 140 may assign the address 110 to the client 105 for providing access to a Wi-Fi network before finishing authenticating the client 105 based on the first response 130a from the client 105 and to the second response 130b from the server 105. The authenticator 140 may receive the first response 130a and the second response 130b to finish authenticating the client 105 to the server 115 based on said first and second responses.

The server 115, i.e., the AAA server may comprise a server module 145 which interfaces with a database (dB) 150 of subscriber information including, user names, passwords, and other related information. The server module 145 may store instructions to mutually authenticate the client 105 to the access network 100 in response to a communication between the client 105 and the server 115 over, for example, a wireless network. For validating the client 105, the database 150 may include client passwords, or other secret indications stored within a subscriber database.

Consistent with one embodiment, the client 105 may include a client module 155 storing instructions for mutually authenticating to the access network 100, for example, through an access point (AP) associated with a wireless network. By using the authenticator 140, the server 115 may be adapted to communicate with the client 105 and reduce a period during which no communication is possible by combining authentication with address acquisition. The authenticator 140 may enable early access to the access network 100 while the server 115 checks credentials of the client 105. The authenticator 140 may combine authentication with address acquisition, and to allow the client 105 to use the address 110, such as an IP address issued early without having to wait until the response to a DHCP request is received.

When the client 105 enters a wireless coverage area for the first time and where a mutual challenge-response based authentication (which always requires at least 3 messages), the authenticator 140 may not be desirable or as effective in the situation set forth above. A fast mutual authentication with early admittance may reduce the time it takes before a client terminal or device may use the access network 100. Such a significantly reduced time is of a particular importance during handovers with existing sessions.

Since an authentication is mutual, i.e., both the client 105 to communicate with the access network 100 and the access network 100 to communicate with the client 105, if the client 105 includes the authenticator 140 but the access network 100 does not, an authentication sequence may reduce to a default DHCP procedure. The client 105 may still proceed, possibly warning the user that this is a non-secure connection (such that the user may then, e.g., use Virtual private Network (VPN). However, this situation may be detected when a DHCP Offer message from the intermediate server 125 does not comprise a client_challenge.

If the access network 110 supports the mutual authentication, as described above, but the client 105 does not, the access network 100 may selectively authenticate such clients based on a policy. This is the case when an initial Discover message does not contain a server_challenge. An alternative authentication may be used instead, e.g., a web-based or the like. In this way, the authenticator 140 may co-exist with other authentication methods. In one embodiment, additional features may include adding Mobile-IP registration related information to an initial DHCP Offer and adding Quality of Service (QoS) negotiation related parameters to the initial DHCP Offer.

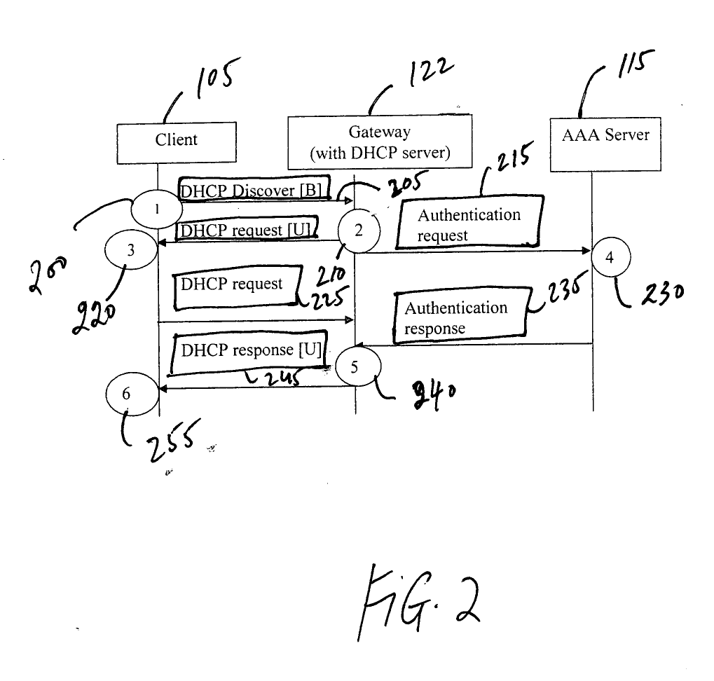

Referring to FIG. 2, the client side communication 120a and the server side communication 120b between the client 105, the gateway 122 with the intermediate server 125 as the DHCP server and the server 115 being an AAA server are illustrated in accordance with one embodiment of the present invention. At block 200, the client 105 may generate a server_challenge and send that along in a DHCP Discover broadcast [B] 205, in addition to a username and realm (e.g., client@domain.com). For the DHCP, the realm may be realized by using a public IP address in the ‘siaddr’ field, as one example.

At block 210, the gateway 122 may determine an AAA server, i.e., the server 115 to which the DHCP Discover broadcast [B] 205 belongs to in a given domain. If known, the gateway 122 may generate a client_challenge. The gateway 122 may also select the address 110, such as an IP address for the client 105 and sends that back, including the client_challenge. The gateway 122 may enable communication from and to this IP address (e.g., for a time-limited period larger than a typical response time for the AAA server 115). The gateway 122 may formulate an authentication request 215 comprising the server_challenge and the client_challenge, and sends that to the AAA server 115. The gateway 122 may realize the communication based on RADIUS or Diameter protocols.

At block 220, the client 105 may receive the IP address and immediately starts using it. In addition, the client 105 may respond to the client_challenge received from the gateway 122 by calculating a response based on a shared secret with the AAA server 115 (e.g., a password, response is some cryptographic function of the password and the challenge like MD5 or SHA1). This response is sent back to the gateway 122 in a DHCP request 225.

At block 230, the AAA server 115 may look up the user in the database 150. The AAA server 115 may calculate responses for both the client_challenge and the server_challenge based on the secret shared with the client 105. The AAA server 115 may respond to the gateway 122 with an authentication response 235 to both challenges, and other parameters relevant to a user's session. If the user is not found in the database 150, the AAA server 115 may not respond at all.

At block 240, once the gateway 122 receives both responses in the authentication response 235 to both challenges, the gateway 122 may compare the outcomes. If the response from the client 105 to the client_challenge matches the response from the server 115, the client 105 is successfully authenticated to the access network 100. If there is no match or the server 115 returned an error, authentication fails and the gateway 122 blocks all traffic from and to the address 110 previously assigned to the client 105. If a timer started when an IP address was issued fires, this is treated as a failure response from the AAA server 115.

In case of the success, the gateway 122 stops the timer and sends a DHCP response [U] 245 back to the client 105, confirming the allocated IP address. The gateway 122 includes the server's response to the server_challenge, and other desired parameters provided by the AAA server 155, such as allocated QoS resources and limits, other configuration parameters, etc. In case of the failure, the gateway 122 sends a DHCP-deny response back to the client 105, possibly with a reason code indicative of failure to mutually authenticate. At block 255, the client receives the DHCP response [U] 245 from the gateway. If authentication is successful, the client 105 may calculate a response for the server_challenge and verify that the response of the server 115 matches thereto. If not, the client 105 may selectively seize all communication, since the access network 100 is not authenticated. Alternatively, the client 105 may use this as an indication that secure communication (such as use of virtual private network (VPN)) is desired. In other words, the client 105 may continue at its own risk.

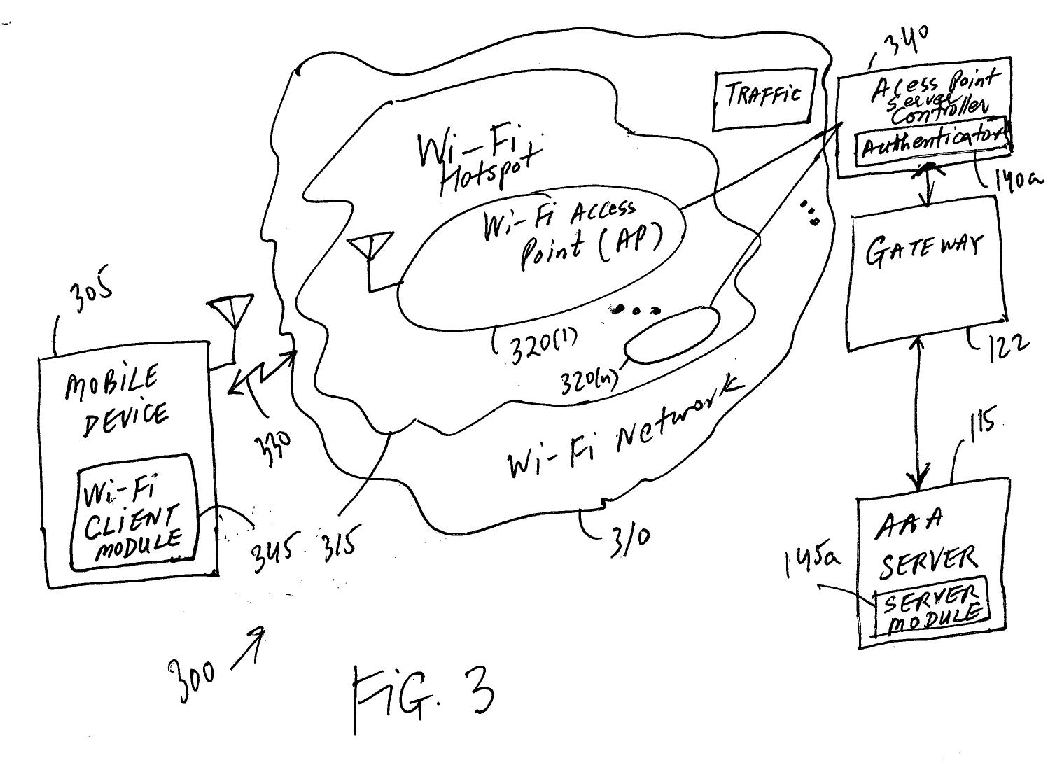

Referring to FIG. 3, a wireless client-server communication system 300 is illustrated to include a mobile device 305 coupled to the AAA server 115 to mutually authenticate with a Wi-Fi network 310, in accordance with one embodiment if the present invention. In one embodiment, the mobile device 305 may send a request message to the server 115 over the Wi-Fi network 310 to login onto a Wi-Fi hotspot 315. That is, a data connection may be desired for exchanging Internet Protocol (IP) data packets.

A conventional Wi-Fi network uses a radio frequency (RF) in the 2.4 Giga Hertz (GHz) range to transmit data between Wi-Fi-enabled, computing or communication devices and other processor-based devices including wireless communication-enabled networked devices. Each wireless communication-enabled networked device comprises a transceiver. The Wi-Fi network typically comprises a wireless router that communicates with a Wi-Fi-enabled computing or communication device, such as computer. Most common form of the Wi-Fi network is based on IEEE 802.11x standard (x: a, b, g, etc.). Depending on local regulations, the IEEE 802.11 standard allows use of up to fourteen Wi-Fi channels within the 2.4 GHz frequency range.

The Wi-Fi hotspot 315 may include a plurality of access points (APs) 320 (1-n) that support the Wi-Fi network 310. The plurality of access points (APs) 320 (1-n) associated with the Wi-Fi network 310 may provide access to data networks, such the Internet. To provide a wireless service to an authorized user, the mobile device 305 may mutually authenticate the user to the Wi-Fi network 310. That is, signaling messages may be exchanged between the mobile device 305 and the Wi-Fi network 310 over a wireless connection 330.

Examples of wireless client-server communication system 300 include a Third Generation (3G) network based on a Universal Mobile Telecommunication System (UMTS) protocol, although it should be understood that the present invention may be applicable to other systems or protocols that support multi-media, data, optical, and/or voice communication. For instance, protocols like Code Domain Multiple Access (CDMA) and General Packet Radio Service (GPRS) for GSM networks may be used. That is, it should be understood, however, that the configuration of wireless client-server communication system 300 of FIG. 3 is exemplary in nature, and that fewer or additional components may be employed in other embodiments of wireless client-server communication system 300 without departing from the spirit and scope of the instant invention.

According to one embodiment, wireless client-server communication system 300 may comprise one or more data networks, such an Internet Protocol (IP) network comprising the Internet and a public telephone system (PSTN). In the wireless client-server communication system 300, the Wi-Fi network 120 may be based on a wireless network protocol that uses unregulated spectrum for establishing a connection, such as a wireless connection between the mobile device 305 and the Wi-Fi network 310. Over the wireless connection, for example, the user often communicates high-speed multimedia information including voice, data, and video content.

The mobile device 305 may take the form of any of a variety of devices, such as mobile terminals including cellular phones, personal digital assistants (PDAs), laptop computers, digital pagers, wireless cards, and any other device capable of accessing the Wi-Fi network 310. The Wi-Fi network 310 may interface with base stations for establishing a communication link with the mobile device 305, such as for cellular WANs, for example. The access point 125 may support the provisioning of multiple virtual networks, identified by a service set identifier (SSID), which is a unique label that distinguishes one WLAN from another.

By mutually authenticating the mobile device 305 and the Wi-Fi network 310, an access point controller 340 comprising a Wi-Fi user authenticator 140a in the wireless client-server communication system 300 may provide access to the access point 320(1) for many authorized users at the Wi-Fi hotspot 315. Of course, the Wi-Fi hotspot 133 is sometimes referred to as the Wi-Fi network 310. The authentication process may involve sending a request message 135 from the wireless communication device 115, and in turn, receiving a reply message over the wireless connection 130, such as a wireless connection from the WAN.

In one embodiment, the mobile device 305 may comprise a Wi-Fi client module 345. The Wi-Fi client module 345 may comprise instructions, such as a software program or a firmware. The Wi-Fi client module 345 may be defined at least in part by an Institute of Electrical and Electronics Engineers (IEEE) 802.11x standard, e.g., x=a, b, g etc.

Likewise, consistent with one embodiment, the access point 125 may comprise a Wi-Fi transceiver. The Wi-Fi user authenticator 140a may comprise instructions, such as a software program or a firmware for providing network authentication. A server module 145a at the server 115 may be defined at least in part by an Institute of Electrical and Electronics Engineers (IEEE) 802.11x standard, where x is a, b, g etc.

To mutually authentication a user within the wireless client-server communication system 300, the Wi-Fi client module 345 and the server module 145a may cooperatively use the Wi-Fi user authenticator 140a. Upon entering the Wi-Fi hotspot 315 space, communication between the Wi-Fi client module 345 and the Wi-Fi user authenticator 140a through the Wi-Fi access point 320(1) may occur, in some embodiments. The mobile device 105 may indicate an authentication event to the Wi-Fi network 310 at the Wi-Fi hotspot 315. The authentication event may be generated when a user desires access to the Wi-Fi network 310 and/or the mobile device 305 interacts with the Wi-Fi hotspot 315 for accessing the Wi-Fi network 310.

In response to the authentication event, the Wi-Fi client module 345 may interact with the Wi-Fi authenticator 140a associated with the server module 145a to allow the mobile device 305 to connect to the access point 320(1) associated with the Wi-Fi network 310.

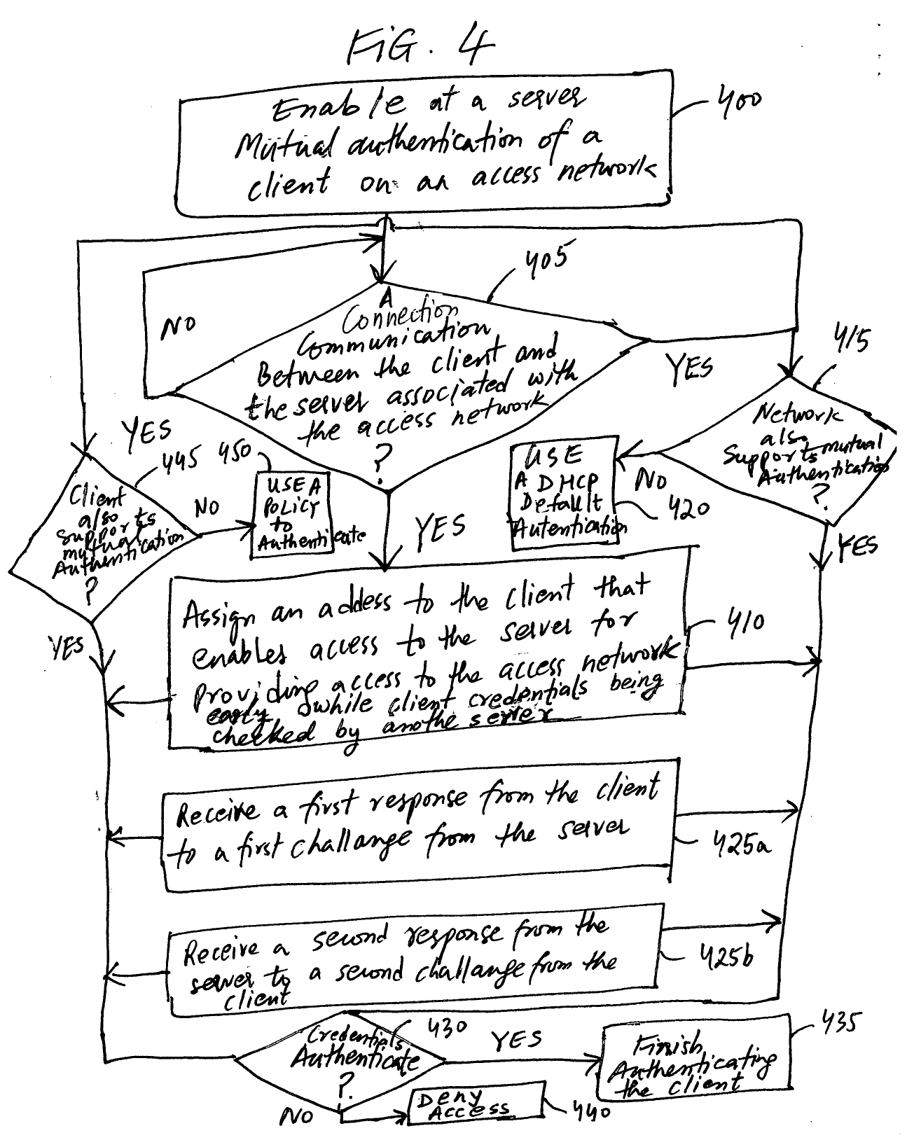

Turning now to FIG. 4, a stylized representation for implementing a method of for authenticating the client 105 on the access network 100 shown in FIG. 1 is illustrated in accordance with one embodiment of the present invention. The access network 100 having the address 110 may enable an early access to the server 115 for the client 105. At block 400, mutual authentication of the client 105 on the access network 100 shown in FIG. 1 may be enabled at the intermediate server 125. To mutually authenticate the client 105 to the access network 100 the intermediate server 125 between the client 105 and the server 115 may be used. In response to a connection communication between the client 105 and the server 115, the authenticator 140 may determine whether at least one of the client 105 and the access network 100 supports a mutual authentication protocol.

A decision block 405 may a connection communication between the client 105 and the intermediate server 125 associated with access network 100. At block 410, the gateway 122 may assign the address 110 to the client 105 for providing access to the access network 100 before finishing authenticating the client 105 based on the first response 130a from the client 105 to the first challenge 135a from the server 115 and the second response 130b from the server 115 to the second challenge 135b from the client 105, in response to the communications 120a, 120b between the client 105 and the server 115 over the access network 100.

In response to determining that the access network 100 does not support the mutual authentication protocol, at block 415, the authenticator 140 may use a default authentication for the client, as indicated in clock 420. At block 425a, the authenticator 140 may receive the first response 130a from the client 105 to the first challenge 135a from the server 115. At block 425b, the authenticator 140 may receive the second response 130b from the server 115 to the second challenge 135b from the client 105.

To validate the access provided to the client 105 on the access network 100, the authenticator 140 may receive an indication of credentials for the client 105 from the server 115, at a decision block 430. The authenticator 140 may finish authenticating the client 105 to the server 115 based on the first and second responses, at block 435.

By using the indication of credentials for the client 105, the authenticator 140 may provide access to the mobile device 305 to the access point 320(1) associated with the Wi-Fi hotspot 315. If the indication of credentials for the client 105 from the server 115 authenticates the access, at block 435, the authenticator 140 may finish authenticating the client 105. However, if the indication of credentials for the client 105 from the server 115 fails to authenticate the access network 100, denying the authenticator 140 may deny access to the client 105 on the access network 100. In response to determining that the client 105 does not support the mutual authentication protocol, at block 445, the authenticator 140 may use a predetermined policy to authenticate the client 105, as indicated in clock 450.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method of authenticating a client on a wireless network having an address that enables access to a server associated with said wireless network, the method comprising:
in response to a communication between said client and said server over said wireless network, assigning said address to said client for providing access to said wireless network before finishing authenticating said client based on a first response from said client to a first challenge from said server and a second response from said server to a second challenge from said client.

2. A method, as set forth in claim 1, further comprising:
comparing said first response from said client to said second response from said server; and
if said first response matches said second response, authenticating said client for said server.

3. A method, as set forth in claim 2, further comprising:
receiving said first response from said client to said first challenge from said server and said second response from said server to said second challenge from said client to finish authenticating said client to said server based on said first and second responses.

4. A method, as set forth in claim 3, wherein receiving said second response from said server further comprises:
receiving an indication of credentials for said client from said server to validate said access provided to said client on said wireless network.

5. A method, as set forth in claim 4, further comprising:
using said indication of credentials for said client to provide access to a mobile device to an access point associated with a Wi-Fi hotspot.

6. A method, as set forth in claim 4, further comprising:
if said indication of credentials for said client from said server authenticates said access, finishing authenticating said client.

7. A method, as set forth in claim 6, further comprising:
if said indication of credentials for said client from said server fails to authenticate said access, denying access to said client on said wireless network.

8. A method, as set forth in claim 1, further comprising:
enabling at an intermediate server between said client and said server to mutually authenticate said client to said wireless network; and
in response to a connection communication between said client and said server, determining whether at least one of said client and said wireless network supports a mutual authentication protocol.

9. A method, as set forth in claim 8, further comprising:
in response to determining said wireless network does not support said mutual authentication protocol, using a default authentication for said client.

10. A method, as set forth in claim 8, further comprising:
in response to determining said client does not support said mutual authentication protocol, using a predetermined policy to authenticate said client.

11. A wireless client-server communication system to authenticate a client to a Wi-Fi network having an address that enables access to a server associated with said Wi-Fi network, said wireless client-server communication system comprising:
a client including a client module storing instructions for mutually authenticating to said wireless network through an access point associated with said wireless network; and
a server adapted to communicate with said client using an authenticator, said server including a server module storing instructions to mutually authenticate said client to said wireless network in response to a communication between said client and said server over said wireless network, said authenticator to assign said address to said client for providing access to said Wi-Fi network before finishing authenticating said client based on a first response from said client to a first challenge from said server and a second response from said server to a second challenge from said client.

12. A wireless client-server communication system, as set forth in claim 11, wherein said authenticator to compare said first response from said client to said second response from said server and if said first response matches said second response, authenticate said client for said server.

13. A wireless client-server communication system, as set forth in claim 12, wherein said authenticator to receive said first response from said client to said first challenge from said server and said second response from said server to said second challenge from said client to finish authenticating said client to said server based on said first and second responses.

14. A wireless client-server communication system, as set forth in claim 11, wherein said authenticator to receive an indication of credentials for said client from said server to validate said access provided to said client on said Wi-Fi network.

15. A wireless client-server communication system, as set forth in claim 12, wherein said authenticator to enable at an intermediate server between said client and said server to mutually authenticate said client to said Wi-Fi network.

16. A client in a wireless client-server communication system to authenticate a client to an access network having an address that enables access to a server associated with said access network, said client comprising:
a client module storing instructions for mutually authenticating to a server module through an intermediate server that in response to a communication between said client module and said server module over said access network to assign said address to said client for providing access to said access network before finishing authenticating said client based on a first response from said client to a first challenge from said server and a second response from said server to a second challenge from said client.

17. A client, as set forth in claim 16, wherein said client is a mobile device.

18. A client, as set forth in claim 16, wherein said access network is a Wi-Fi network.

19. A server in a wireless client-server communication system to authenticate a client to an access network having an address that enables access to said server associated with said access network, said server comprising:
a server module storing instructions for mutually authenticating to a client module through an intermediate server that in response to a communication between said client module and said server module over said access network to assign said address to said client for providing access to said access network before finishing authenticating said client based on a first response from said client to a first challenge from said server and a second response from said server to a second challenge from said client.

20. A server, as set forth in claim 21, wherein said server is an authentication server associated with a Wi-Fi network.
